(19) United States
(12) Patent Application Publication
(10) Pub. No.: US 2026/0301016 A1
(43) Pub. Date: Oct. 1, 2026

(54) STATE-FUNDED TOKENIZATION SYSTEM (StFT): A MULTI-CYCLE, GEO-FENCED FRAMEWORK FOR GOVERNMENT-BACKED DIGITAL ASSETS, INCENTIVES, AND EMERGENCY FUNDING

(71) Applicant: Michael A. Fesi, II, Houma, LA (US)

(72) Inventor: Michael A. Fesi, II, Houma, LA (US)

(21) Appl. No.: 19/577,008

(22) Filed: Mar. 24, 2026

Related U.S. Application Data
(60) Provisional application No. 63/777,875, filed on Mar. 26, 2025.

(51) Int. Cl. G06Q 30/0207

(52) U.S. Cl. CPC G06Q 30/0224

(57) ABSTRACT

A blockchain-based digital token system enables state governments to transform government-issued fiscal incentives into geo-fenced, multi-cycle digital tokens. Each token is minted on a permissioned blockchain, pegged at a one-to-one ratio to a fiat currency, and backed by a state-managed reserve account. Tokens are issued in a non-redeemable state and must complete a configurable number of validated transactions within an authorized geographic boundary before becoming eligible for redemption. A geo-fencing module performs two-point authentication for each transaction by verifying merchant identity against a registry and comparing cryptographically signed location data against permissible geographic regions. A smart contract engine increments a usage counter for each validated transaction and updates the token to a redeemable state upon meeting the threshold. Users interact through a dual-compartment digital wallet displaying non-redeemable and redeemable tokens separately. Upon redemption, tokens are permanently burned to maintain supply alignment with the fiat reserve.

### CROSS-REFERENCE TO RELATED APPLICATIONS

The present application claims priority to U.S. Provisional Application No. 63/777,875 filed Mar. 26, 2025, titled “STATE-FUNDED TOKENIZATION SYSTEM (StFT): A MULTI-CYCLE, GEO-FENCED FRAMEWORK FOR GOVERNMENT-BACKED DIGITAL ASSETS, INCENTIVES, AND EMERGENCY FUNDING,” which is hereby incorporated by reference.

### TECHNICAL FIELD

The embodiments generally relate to the technical field of blockchain-based digital asset systems, and more specifically, to a state-managed tokenization framework for transforming government-issued fiscal incentives into geo-fenced, multi-cycle, and traceable digital tokens.

### BACKGROUND

State tax incentives and economic development programs serve as widely used mechanisms by which governments stimulate local economies, attract businesses, and support workforce growth. These incentives typically take the form of tax credits, rebates, or grants delivered through established fiscal channels. Electronic Benefits Transfer (EBT) systems, for example, deliver government-issued benefits via digital cards that restrict spending to approved merchant categories. While EBT systems control the types of purchases a recipient may make, they do not require funds to circulate through multiple transactions within a local economy before a recipient or merchant may freely use them elsewhere. As a result, capital frequently exits the issuing jurisdiction after a single transaction, a phenomenon sometimes referred to as economic leakage, which diminishes the intended local impact of the disbursed funds.

Private barter networks and alternative digital payment platforms have also sought to introduce localized or purpose-bound transaction models. Barter networks allow participants to exchange goods and services using internal credits rather than cash, but these credits generally lack backing by any governmental authority, which limits participant confidence in their value and constrains adoption at scale. Alternative digital payment systems, including certain blockchain-based financial platforms operating under a Blockchain-as-a-Service model, provide secure transaction infrastructure and transparent record-keeping. However, these platforms generally do not incorporate mechanisms that enforce repeated circulation of digital assets within a defined geographic area or that require assets to complete a specified number of validated transactions before becoming eligible for conversion to fiat currency.

Across these conventional approaches, a common limitation persists: once funds or credits are disbursed, the issuing authority retains minimal control over how many times those funds circulate within the local economy, whether recipients spend them within the intended geographic region, or how effectively each disbursed dollar generates downstream economic activity. Existing systems may address one or more of these concerns in isolation, but none integrates geographic transaction enforcement, mandatory multi-transaction circulation, and real-time auditability into a unified framework operating under government oversight.

Electronic Benefits Transfer systems restrict the categories of purchases a recipient may make but do not require funds to complete a minimum number of validated transactions within a local economy before becoming eligible for unrestricted use, allowing capital to exit the issuing jurisdiction after a single transaction. Central Bank Digital Currency initiatives operate under federal monetary policy frameworks and are designed as general-purpose digital representations of sovereign currency, rather than as state-level instruments that mandate economic circulation within a defined geographic boundary before redemption. Generic Blockchain-as-a-Service platforms provide distributed ledger infrastructure and transaction processing capabilities but do not natively enforce geographic containment of token transactions or require tokens to achieve a multi-cycle circulation threshold as a precondition to redemption.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

The disclosed system provides a blockchain-based digital token system, referred to as the State Funded Tokenization System (StFT), that enables state governments to transform approved fiscal instruments, such as tax credits, rebates, subsidies, and emergency relief disbursements, into digital tokens that must circulate locally through a predefined number of validated transactions before becoming eligible for redemption. Each digital token is minted on a permissioned blockchain, pegged at a one-to-one ratio to a fiat currency such as the U.S. Dollar, and backed by a corresponding amount held in a state-managed reserve account. Upon issuance, each token is assigned a unique identifier and initialized with metadata including a usage counter, a redemption status set to non-redeemable, and location-related attributes defining an authorized geographic boundary. By requiring tokens to complete multiple transaction cycles within a designated region before redemption, the system addresses the problem of capital exiting the issuing jurisdiction after a single transaction.

The system enforces geographic restrictions on token transactions through a geo-fencing module that performs a two-point authentication process for each transaction. The first authentication step verifies the identity of the receiving merchant by cross-referencing the merchant's registered digital certificate against a merchant registry. The second authentication step compares real-time, cryptographically signed location data transmitted during the transaction against a whitelist of permissible geographic regions. Transactions that fail either authentication step are automatically rejected by the system. This two-point geo-fencing mechanism provides a level of geographic transaction enforcement that conventional benefit disbursement systems and digital payment platforms do not offer.

A smart contract engine deployed on the permissioned blockchain manages the lifecycle of each token by incrementing the usage counter upon each validated transaction and evaluating whether the counter meets or exceeds a configurable transaction cycle threshold. Upon meeting the threshold, the smart contract engine updates the token's redemption status from non-redeemable to redeemable. Users interact with the system through a dual-compartment digital wallet interface that visually separates non-redeemable tokens still in circulation from redeemable tokens eligible for conversion to fiat currency. This wallet structure provides users with real-time visibility into the status, transaction history, and cycle count of each token they hold.

Upon reaching redeemable status, tokens may be redeemed through multiple pathways, including a state treasury exchange interface for larger redemptions and retail channels such as automated teller machines and digital banking platforms for smaller redemptions. Once redeemed, a smart contract executes a token burning operation that permanently removes the token from circulation on the blockchain and records the burn event on the distributed ledger. This burning mechanism maintains alignment between the circulating token supply and the underlying fiat reserve, preserving supply integrity and reinforcing the stability of the token's value peg. Every token transaction, issuance event, and redemption operation is immutably recorded on the permissioned blockchain, providing state administrators with a comprehensive audit trail and real-time transparency into how disbursed incentive funds are utilized within the local economy.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3 illustrates a block diagram indicative of the operational flow of the state funded tokenization system, according to some embodiments;

FIG. 4 illustrates a block diagram indicative of the operational flow of the digital treasury mint within the state funded tokenization system, according to some embodiments;

FIG. 5 illustrates a block diagram indicative of a lifecycle of a state-backed digital token from issuance through circulation and potential redemption, according to some embodiments;

FIG. 6 illustrates a block diagram indicative of the economic and transactional flow of state-backed digital tokens from issuance to final removal from circulation, according to some embodiments;

FIG. 7 illustrates a block diagram indicative of a multi-source geo-verification flow showing how location data from a plurality of independent verification sources is processed through a cross-source consistency engine, according to some embodiments; and

FIG. 8 illustrates a block diagram indicative of a fraud detection flow showing how transaction data is analyzed by a machine learning pattern engine to detect velocity anomalies, ring-laundering patterns, and related-party transactions, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

A blockchain-based digital token system, which may be referred to as the State Funded Tokenization System or StFT, enables state governments to transform approved financial instruments into digital tokens that circulate locally before they may be redeemed. The system may operate by issuing stable, state-backed digital tokens, each pegged at a one-to-one ratio to a fiat currency such as the U.S. Dollar. These tokens may be minted via a smart contract system and backed by a corresponding amount held in a state-managed reserve account. Upon issuance, tokens may be delivered to recipients in a non-redeemable state and must complete a predefined number of validated transactions within authorized geographic boundaries before becoming eligible for redemption. Each transaction involving a token may be recorded on a permissioned blockchain. The system may include logic to track token usage, enforce transaction counts, and validate geographic boundaries. The system may be configured to be deployed in various types of state-issued financial instruments beyond tax incentives, such as emergency relief disbursements, natural disaster recovery funds, infrastructure project credits, and public health funding allocations.

The system may operate across a distributed computing infrastructure that integrates financial applications, application programming interfaces (APIs), and cryptographic protocols. A computing system suitable for executing the processes described herein may include one or more processors coupled to a memory through a system bus. The memory may include computer-readable application instructions configured to implement the embodiments described herein, and a database comprising various data accessible by the application instructions. The application instructions may reside in random access memory (RAM), flash memory, read-only memory (ROM), erasable programmable read-only memory (EPROM), electrically erasable programmable read-only memory (EEPROM), registers, a hard disk, a removable disk, a compact disc read-only memory (CD-ROM), or any other form of storage medium known in the art. The application instructions may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages.

The computing system may include one or more input/output devices, such as video devices, audio devices, and displays, which may be in operable communication with the computing system through wired or wireless connections. The computing system may include one or more interfaces that allow the computing system to interact with other systems, devices, or computing environments. These interfaces may include a network interface configured to allow data to be exchanged between the computing system and other devices attached to a network, a user interface, and a peripheral device interface. The network may correspond to a local area network, a wide area network, the Internet, a direct peer-to-peer network, or an indirect peer-to-peer network. The computing system may include a user computing device utilized by a user to interact with the various functionalities of the system, an administrator computing device utilized by an administrative user to moderate content and perform administrative functions, and a third-party computing device utilized by third parties to receive communications from the user computing device and to otherwise interact with the system via the network.

The computing system operating an application program may comprise several modules and engines configured to execute the functionalities of the system. The application program may include a state funded tokenization system, a blockchain module, a geo-fencing module, a fraud detection module, a reserve management module, a policy configuration module, a communication module, a database engine, a user module, and a display module. These modules and engines may contain the necessary routines and data structures for performing specific tasks, and one or more engines may be configured to determine how the platform manages and manipulates data.

The state funded tokenization system may be configured to issue, track, and manage the lifecycle of digital tokens representing state-backed financial incentives. These tokens may correspond to tax credits, rebates, subsidies, emergency relief disbursements, natural disaster recovery funds, infrastructure project credits, public health funding allocations, or other approved funding instruments. The module may interface directly with a state treasury or administrative system to receive authorization for token issuance. Upon approval, the module may generate digital tokens pegged at a one-to-one ratio to a fiat currency such as the U.S. Dollar. Each token may be assigned a unique identifier and linked to a record of the underlying fiscal incentive. Token issuance may be executed via smart contract logic deployed to the permissioned blockchain. The state funded tokenization system may enforce a multi-transaction requirement by initializing a usage counter for each token. Each time the token is transferred within the system, the module may verify transaction validity and increment the counter. Tokens may remain non-redeemable until they complete a predefined number of validated transactions. The predefined number may be configurable, such as seven transactions, and may be set according to state policy. Validation may include confirming that each transaction occurred within an authorized geographic boundary using integrated geo-fencing tools. To enforce location constraints, the module may access merchant registry data and real-time, cryptographically signed location inputs at the point of sale. Smart contracts within the module may compare this data against stored authorization zones. Invalid or out-of-bounds transactions may be rejected. The module may also communicate with user wallet systems to update token status and compartmentalize balances into non-redeemable and redeemable categories. Upon reaching redeemable status, the module may enable redemption through approved exchange pathways. A successful redemption may trigger a burn operation, permanently removing the token from circulation and logging the event to the blockchain. The module may also support audit functions, generate compliance reports, and provide administrative override capabilities for authorized state personnel.

The blockchain module may be configured to record, validate, and enforce all token-related transactions and smart contract logic within a permissioned distributed ledger. This module may serve as the foundational infrastructure for the issuance, circulation tracking, geo-fencing enforcement, and redemption lifecycle of state-backed digital tokens. The blockchain module may include a node-based architecture operated by authorized entities such as state agencies, financial institutions, or designated partners. These nodes may maintain synchronized copies of the ledger and participate in a consensus mechanism, such as Proof-of-Authority or Proof-of-Stake, to ensure transaction validity, fault tolerance, and security without the computational cost of Proof-of-Work protocols. Smart contracts deployed within the module may manage token operations including minting, updating transaction counts, verifying geographic constraints, marking tokens as redeemable, and initiating token burns upon redemption. Each smart contract execution may be triggered by user actions, merchant transactions, or administrative events, with results permanently recorded to the blockchain. The blockchain module may also interface with off-chain components via secure APIs. For example, the module may receive cryptographically signed location data from point-of-sale systems or geo-location oracles, validate these inputs, and enforce geo-fencing policies before approving a token transfer. To support transparency and compliance, the module may generate immutable records of all token activities, including issuance timestamps, transaction histories, redemption events, and burn confirmations. These records may be accessed through audit dashboards or exposed through reporting APIs for real-time monitoring by regulatory stakeholders. The blockchain module may also provide secure key management, encryption protocols, and access controls to protect user data and prevent unauthorized transactions.

In certain embodiments, the blockchain module may implement a composite consensus mechanism referred to as Proof of State. The Proof of State mechanism may comprise five interoperating verification components. A first component, Proof of Reserve, may verify that each minted digital token corresponds to an equivalent amount of fiat currency held in the state-managed reserve account, thereby maintaining the one-to-one peg between circulating tokens and the underlying reserve. A second component, Proof of Authority, may enforce multi-party approval requirements for critical token operations including minting, parameter modification, and administrative override actions, requiring cryptographic signatures from a configurable quorum of authorized entities before such operations are committed to the ledger. A third component, Proof of Compliance, may perform real-time verification of each token operation against applicable state statutes and regulatory requirements, rejecting operations that would violate configured compliance rules. A fourth component, Proof of Participation, may strengthen network validation proportionally as additional authorized entities join the permissioned blockchain network, such that consensus reliability and fault tolerance increase with the number of participating nodes. A fifth component, Proof of Validation, may execute distributed consistency checks across nodes in the permissioned blockchain network to detect and resolve discrepancies between ledger copies maintained by different nodes. The Proof of State mechanism may be selectable as an alternative to Proof-of-Authority or Proof-of-Stake through a consensus configuration parameter maintained in the policy configuration store.

The geo-fencing module may be configured to restrict the use of state-backed digital tokens to authorized geographic areas by validating the physical location of each transaction. This module may ensure that token circulation is localized within a designated boundary, such as a specific state, county, municipality, or economic zone, thereby supporting policy goals for in-state reinvestment and economic retention. The geo-fencing module may operate by verifying two inputs during each transaction: the identity of the merchant and the real-time location where the transaction is occurring. The module may first retrieve a merchant's registered profile, which may include a digital certificate and static geographic coordinates. This information may be stored on-chain or in a secure registry accessible via an API. At the time of transaction, the module may receive dynamic location data from the merchant's point-of-sale system or device. This data may include GPS coordinates or similar geospatial information, cryptographically signed to ensure authenticity and prevent spoofing. The geo-fencing module may then perform a two-point authentication process: confirming the merchant's registered identity and verifying that the transaction location falls within the approved geographic boundary. If both conditions are met, the module may allow the transaction to proceed and update the token's usage count. If either condition fails, the transaction may be rejected, and a notification may be sent to the user or the administrative system. The module may also log the validation outcome for auditing purposes. The authorized geographic boundary may be defined at varying levels of granularity, including state boundaries, county boundaries, municipal boundaries, or designated economic zones, and may be reconfigurable by a state administrator without requiring modification to the underlying smart contract code.

In certain embodiments, the geo-fencing module may receive location data from a plurality of independent verification sources comprising GPS coordinates obtained from the point-of-sale device, cellular network triangulation data, IP address geolocation data, and device hardware identifiers. The geo-fencing module may perform cross-source consistency verification by comparing location signals across these independent sources. A transaction may be flagged for rejection when discrepancies between sources exceed a configurable tolerance threshold, providing detection of location spoofing attempts in which one data source is manipulated while others are not.

The system may incorporate a fraud detection subsystem configured to identify artificial manipulation of the multi-cycle circulation requirement. The fraud detection subsystem may employ machine learning algorithms trained to analyze transaction patterns, timing relationships, and entity relationship graphs recorded on the permissioned blockchain. The subsystem may monitor for: velocity anomalies in which a token completes an unusually high number of transaction cycles within a compressed time period; ring-laundering patterns in which a token circulates between a closed set of entities without genuine economic activity; and related-party transactions in which sender and receiver share common ownership or Employer Identification Number (EIN) registration. Upon detection of a flagged pattern, the subsystem may automatically suspend transaction processing for affected tokens, generate an alert to authorized administrators through the administrative dashboard, and record the detected anomaly immutably on the permissioned blockchain.

The communication module may be configured for receiving, processing, and transmitting user commands and data streams between the various devices and components of the system. The communication module may perform communication functions between a user computing device, an administrator computing device, and one or more third-party computing devices via the network. The communication module may be configured to allow one or more users of the system, including third parties, to communicate with one another. The communication module may be configured to maintain one or more communication sessions with one or more servers, administrative computing devices, and third-party computing devices. The communication module may allow users and administrators to communicate with one another regarding token transactions, redemption requests, and system notifications.

The database engine may be configured to facilitate the storage, management, and retrieval of data to and from one or more storage mediums, such as internal databases maintained by the system. The database engine may be coupled to an external storage system or configured to apply changes to one or more databases. The database engine may comprise a search engine component for searching through data sources stored in different locations. The database engine may store token metadata, merchant registry records, user account information, transaction logs, geographic boundary definitions, and policy configuration parameters. The database engine may support queries from other modules within the system, such as the geo-fencing module retrieving merchant location data or the state funded tokenization system accessing token lifecycle records.

The user module may store user preferences including user account information, historical usage data, user personal information, and similar data. The user module may facilitate the creation of user profiles for users, administrators, and others who interact with the system. User profiles may include identity verification data used for regulatory compliance, such as information required for Know Your Customer (KYC) and Anti-Money Laundering (AML) checks. The user module may also store historical token balances, transaction records, and redemption history for each user, enabling the system to present personalized information through the digital wallet interface.

The display module may be configured to display one or more graphic user interfaces, including the digital wallet interface. The display module may be configured to temporarily generate and display various pieces of information in response to one or more commands or operations. The display module may display information, notifications, and alerts to the user device which may be viewed and acknowledged by the user. The digital wallet interface rendered by the display module may present a dual-compartment view. A first compartment may display non-redeemable tokens that have not yet completed the required number of validated transaction cycles. A second compartment may display redeemable tokens that have met or exceeded the configurable transaction cycle threshold and are eligible for conversion to fiat currency. For each token displayed in either compartment, the wallet interface may present the token's current usage counter value, its transaction history showing each prior transfer and the associated merchant, and a geo-verification outcome indicating whether each recorded transaction was validated as occurring within the authorized geographic boundary. The wallet interface may also display the total balance of non-redeemable tokens and redeemable tokens separately, providing the user with a clear view of how many tokens remain in active circulation and how many are available for redemption.

A digital token may be issued by a state authority following the approval of a financial instrument such as a tax credit, rebate, or subsidy. Token issuance may occur through an integrated interface connected to a state's treasury or fiscal management systems. Each token may be minted onto the permissioned blockchain using the blockchain module. Each token may be pegged to a fiat currency at a one-to-one ratio and backed by a reserve held by the issuing authority. The tokenization process may be governed by configurable smart contracts that assign a unique identifier, set an initial usage count of zero, set a redemption status to non-redeemable, and embed redemption conditions including the configurable transaction cycle threshold and the authorized geographic boundary. The token may also be associated with metadata linking it to a specific fiscal instrument, such as a tax credit, a rebate, a subsidy, an emergency relief disbursement, a natural disaster recovery fund, an infrastructure project credit, or a public health funding allocation. This metadata may enable state administrators to track the performance and utilization of specific incentive programs through the audit dashboard.

The system may enforce a multi-cycle transaction model through smart contract logic that tracks how many times each token has been used in validated transactions. The configurable transaction cycle threshold, which may be set to any number such as seven transactions, may be required before a token becomes eligible for redemption. Tokens that have not reached this threshold may be held in a non-redeemable state within the first compartment of the digital wallet. When the required transaction count is met, the smart contract engine may update the token's redemption status to redeemable, and the display module may cause the token to appear in the second compartment of the wallet. The threshold may be configurable on a per-program basis by a state administrator, allowing different incentive programs to require different numbers of circulation cycles based on policy objectives. The threshold may be adjusted without requiring modification to the underlying smart contract code deployed on the permissioned blockchain. This configurability may be achieved through parameterized smart contract templates that read threshold values from a policy configuration store maintained by the database engine.

The token may be implemented as a stablecoin pegged at a one-to-one ratio with a fiat currency such as the U.S. Dollar. This peg may be maintained by securing a corresponding amount in a fiat reserve account managed by the issuing authority. Reserve funds may be stored in a segregated account and periodically audited to ensure parity between tokens in circulation and the fiat backing the system. The system may be configured to maintain the state-managed reserve account such that a total fiat amount in the reserve corresponds to a total value of digital tokens in circulation on the permissioned blockchain. An automated or semi-automated auditing process may periodically verify this parity and generate audit records accessible to state administrators through the administrative dashboard.

Each token may be assigned a unique identifier and metadata including an issuance timestamp, a usage counter, a redemption status, and location-related attributes. Token transfers may be handled by smart contracts that execute on the blockchain. Each time a token is transferred from one party to another, the smart contract engine may increment its transaction count and evaluate whether the configurable transaction cycle threshold has been met. If the threshold is met, the token may be flagged as eligible for redemption by updating its redemption status from non-redeemable to redeemable.

The system may integrate geo-fencing logic by verifying that each token transaction occurs within the authorized geographic boundary. This may involve the two-point authentication process described with respect to the geo-fencing module. When a user initiates a payment, the transaction request may be processed through a series of verification steps. A merchant check may validate the identity of the receiving merchant by cross-referencing the merchant against a pre-approved merchant list stored in the merchant registry. If the merchant is authorized, the process may advance to a location check, where real-time geographic data is retrieved from the merchant's point-of-sale device. The real-time geographic data may be cryptographically signed by the point-of-sale device to prevent spoofing. The system may then perform geo-fence validation to determine if the transaction complies with the geographic constraints. If the transaction is determined to be invalid because the location falls outside the authorized geographic boundary or the merchant is not present in the registry, the transaction may be rejected. If valid, the smart contract engine may execute the necessary token updates, increment the cycle count, and record the transaction on the blockchain ledger.

Once a token meets the predefined circulation threshold, the smart contract engine may update the token's status to redeemable and cause the wallet interface to move the token from the non-redeemable compartment to the redeemable compartment. The user may then initiate a redemption request via the wallet interface. Redemption may be processed through at least two pathways. A first pathway may direct larger redemptions, such as those exceeding a predetermined monetary threshold, through a state treasury exchange interface that connects directly with the state's fiat reserve. A second pathway may direct smaller redemptions, at or below the predetermined monetary threshold, through retail mechanisms such as automated teller machines, partner banks, or digital banking platforms. Redemption processes may incorporate regulatory protocols such as user identity verification, KYC and AML compliance checks, and secure disbursement methods.

Upon successful redemption, a token may be permanently removed from circulation through a token burning process. A smart contract may execute the burn operation automatically, and the event may be recorded to the blockchain ledger to provide a permanent audit record. This mechanism may ensure that the token supply remains consistent with the underlying reserve and that redeemed tokens may not be reused. The burn event may include metadata identifying the token, the redemption pathway used, the timestamp, and the amount of fiat currency disbursed, providing a complete record for compliance purposes.

The system may be deployed across a permissioned blockchain network operated by the state or authorized institutions. Smart contracts may manage all aspects of the token lifecycle, including issuance, circulation tracking, geo-verification, redemption eligibility, and burning. The blockchain may utilize a consensus mechanism such as Proof-of-Authority or Proof-of-Stake to validate operations securely and efficiently. Participation in the permissioned blockchain network may be restricted to trusted entities comprising government agencies, regulated financial institutions, and approved technology providers. Nodes within the network may maintain synchronized ledgers, execute smart contracts, and ensure data integrity across the system.

The system may employ cryptographic methods to secure transactions and validate data. These methods may include public-key encryption, digital signatures, secure key management, and cryptographic hashing. Smart contracts may perform automated validation of location data, transaction counts, and identity checks without requiring manual intervention. Off-chain components, such as APIs and third-party data sources, may support wallet interaction, redemption processing, and fiat settlement.

State agencies may access administrative dashboards to monitor token issuance, usage metrics, economic reinvestment patterns, and compliance reporting. The administrative dashboard may display token velocity metrics indicating the rate at which tokens circulate through the local economy, redemption volume data showing the aggregate value of tokens redeemed over specified periods, transaction heat maps illustrating geographic concentrations of token activity, and economic reinvestment patterns derived from the transaction data recorded on the permissioned blockchain. These visualization tools may support decision-making by displaying how disbursed incentive funds flow through the local economy. The administrative dashboard may be accessible to authorized state personnel through secure, authenticated connections.

The system may be configured to support policy-based variations. For example, administrators may adjust the number of required transaction cycles, redefine geographic boundaries, or deploy tokens pegged to alternative fiat currencies. The modular architecture of the system may allow these updates without requiring changes to the underlying infrastructure. Smart contract templates may support deployment across different jurisdictions or use cases, including localized currencies or incentive-specific tokens. Parameters such as the number of required transaction cycles, redemption limits, geographic boundaries, and token expiration policies may be adjusted through the policy configuration store without modifying the deployed smart contract codebase.

Various implementations of the invention involve the technical field of blockchain-based digital asset systems, including minting, by a state funded tokenization system executing on one or more processors, a plurality of digital tokens on a permissioned blockchain, each digital token pegged at a one-to-one ratio to a fiat currency, backed by a state-managed reserve, and initialized in a non-redeemable state with a usage counter set to zero; delivering the plurality of digital tokens to respective digital wallets of recipient users, each digital wallet comprising a dual-compartment interface with a non-redeemable compartment and a redeemable compartment, wherein each minted digital token is initially placed in the non-redeemable compartment; receiving, at a smart contract engine on the permissioned blockchain, a transaction request to transfer a digital token from a first user to a merchant; performing, by a geo-fencing module, a two-point authentication for the transaction request, the two-point authentication comprising: validating an identity of the merchant by cross-referencing a digital certificate of the merchant against a merchant registry, and verifying that a real-time, cryptographically signed geographic location of the transaction falls within an authorized geographic boundary; upon successful two-point authentication, executing, by the smart contract engine, the transaction request by transferring the digital token, incrementing the usage counter of the digital token, and recording the transaction on the permissioned blockchain; upon a determination that the usage counter of the digital token meets or exceeds a predefined transaction cycle threshold, updating, by the smart contract engine, the digital token from the non-redeemable state to a redeemable state and causing the digital wallet to move the digital token from the non-redeemable compartment to the redeemable compartment; and rejecting, by the geo-fencing module, the transaction request upon a determination that the real-time geographic location falls outside the authorized geographic boundary or that the merchant is not present in the merchant registry and are therefore necessarily rooted in computer technology.

For example, the aforementioned steps are inherently computer-based and cannot be performed in the human mind. The disclosed system amounts to more than merely implementing the generic computer as a tool to gather, analyze, and output data because the steps of the present method, system, or product improve the field of blockchain-based digital asset systems by implementing an integrated, automated enforcement architecture that no conventional system offers.

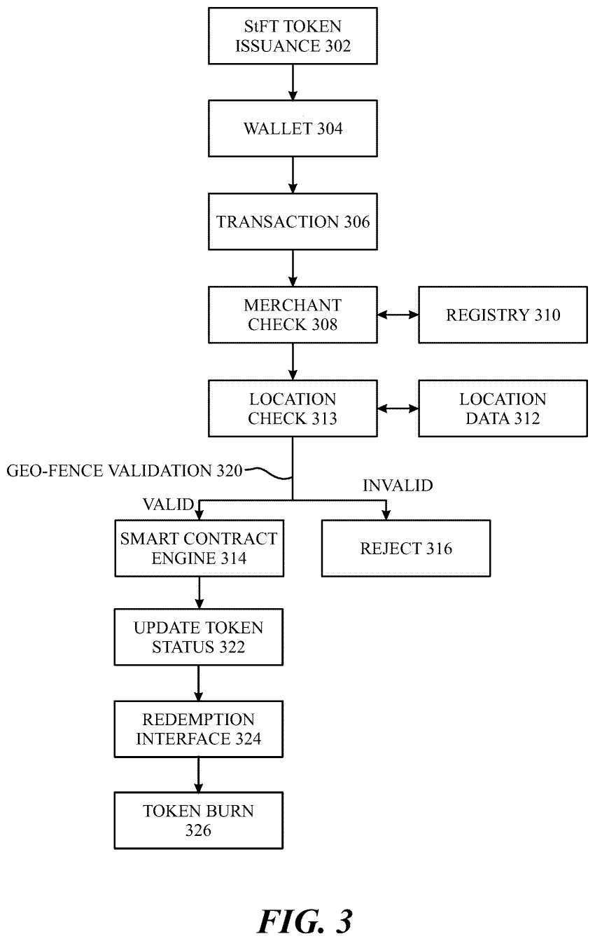

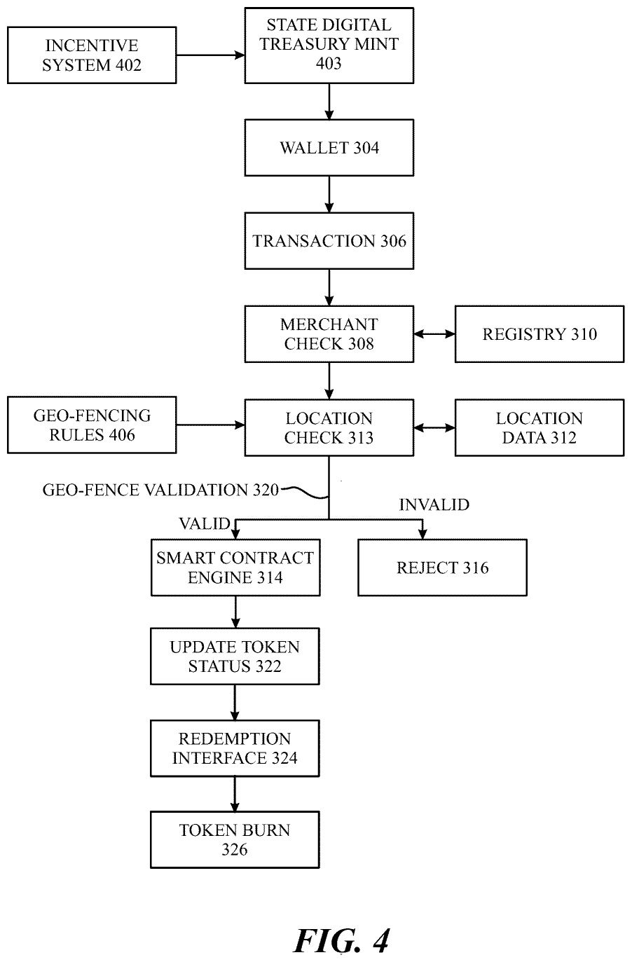

Specifically, the system combines three technical mechanisms operating in concert on a permissioned blockchain: a smart contract engine that programmatically tracks and enforces a multi-cycle transaction threshold for each individual token by maintaining and incrementing a usage counter at the blockchain level, a geo-fencing module that performs real-time, two-point cryptographic authentication at the point of each transaction by validating both a merchant's registered digital certificate and cryptographically signed GPS data against a whitelist of permissible regions, and a dual-compartment digital wallet interface that dynamically reclassifies tokens between non-redeemable and redeemable states based on smart contract outputs. These three components interact through automated smart contract logic that makes transaction-level enforcement decisions, accepting or rejecting transfers, incrementing counters, updating redemption status, and executing irreversible token burns, without human intervention. This is not a matter of applying general-purpose computing hardware to organize a human activity like distributing benefits; rather, the system solves a technical problem (uncontrolled single-use disbursement and geographic leakage) through a specific technical architecture in which the blockchain itself enforces circulation rules, the geo-fencing module cryptographically validates location data at the transaction layer, and the smart contract engine autonomously governs token lifecycle state transitions. The flowcharts in FIGS. 3 and 4 illustrate this solution by showing the automated decision logic, from token issuance through merchant verification, location validation, geo-fence pass/fail branching, smart contract execution, status updates, redemption, and burning, as a machine-driven process in which each step is executed by a specific system component rather than directed by human judgment. Additionally, the steps of the disclosed system would be impossible to accomplish on pen and paper due to the volume of data being communicated and received over a network in real-time. In particular, the speed at which the steps of the disclosed system occur to effectuate the disclosed method, system, or product would involve large-scale, continuous wireless communication of such data. That is, the steps of the present method, system, or product are impossible to accomplish on pen and paper, cannot be accomplished as a method of organizing human activity, and amount to significantly more than merely gathering, analyzing, and outputting data.

Implementations of the disclosed system include implementing (executing, running, or deploying) one or more artificial intelligence models on a computing device wherein the computing device executes the artificial intelligence model's algorithms and mathematical functions on computer hardware using machine learning libraries. The computing device implements the artificial intelligence model when it performs tasks like training, making predictions, applying the model to data, decision-making, classification, or generating outputs based on inputs. In particular, the speed at which an artificial intelligence model analyzes and transforms data to effectuate the disclosed method, system, or product would involve large-scale, continuous transformation of such data. As such, the disclosed system would be impossible to accomplish on pen and paper or in the human mind due to the volume of data being analyzed and transformed by the artificial intelligence model.

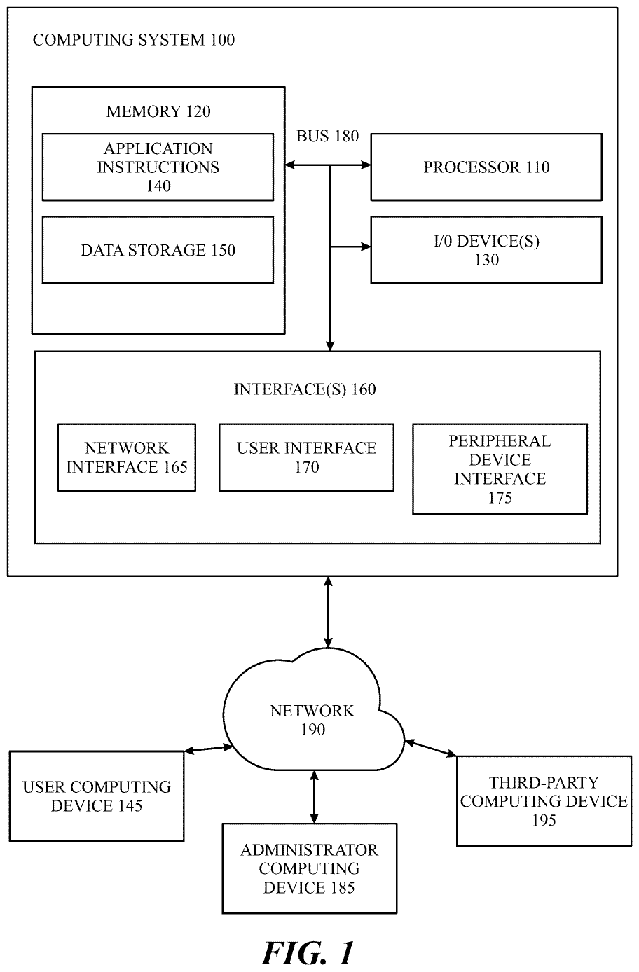

The computing system 100 of FIG. 1 may comprise one or more user devices, one or more merchant or administrator devices, one or more application servers, one or more data stores, and a permissioned blockchain network comprising one or more nodes configured to execute smart contracts and maintain token lifecycle records associated with State-Funded Tokens (StFTs). In some embodiments, the computing system 100 is configured to perform token issuance, geographically restricted transaction validation, transaction-cycle counter maintenance, anomaly and fraud detection, redemption-state control, token burn or deactivation, and reserve or treasury correspondence. The application servers may coordinate authentication, policy enforcement, transaction routing, and communication with the blockchain network, while the data stores may maintain transaction history, audit records, account records, geolocation-related data, and fraud-detection data used in connection with token circulation and redemption. The computing system 100 may further communicate with external geolocation services, fraud-detection modules, payment systems, and treasury or governmental systems to support compliance, auditability, and settlement within the disclosed architecture.

The computing system 100 includes one or more processors 110 operably coupled to a memory 120 via a system bus 180. The processor 110 may be implemented as a general-purpose central processing unit (CPU), a graphics processing unit (GPU), a tensor processing unit (TPU), a digital signal processor (DSP), or any combination thereof. In some embodiments, the processor 110 may be an application-specific integrated circuit (ASIC) or a field-programmable gate array (FPGA).

The memory 120 may include volatile memory, nonvolatile memory, or a combination thereof. Volatile memory may include system RAM or cache memory. Nonvolatile memory may include flash storage, solid-state drives (SSD), or magnetic hard disk drives (HDD). The memory 120 stores application instructions 140 for carrying out the functionalities described herein and data storage 150 for maintaining information related to system operations.

The computing system 100 may also include one or more input/output (I/O) devices 130. These devices may encompass visual output devices such as monitors, input devices such as keyboards, mice, and touchscreens, and sensor devices such as microphones, cameras, and biometric scanners.

The computing system 100 further comprises one or more interfaces 160 that enable communication with other systems, users, or peripheral components. The network interface 165 allows the computing system 100 to exchange data with external systems across a network 190 using wired or wireless protocols such as Ethernet, Wi-Fi, Bluetooth, 5G, or Long-Term Evolution (LTE). In some embodiments, the network interface 165 supports secure protocols such as HTTPS or TLS to ensure authenticated and encrypted data transfer. The user interface 170 may include APIs, graphical user interfaces (GUIs), or command-line interfaces (CLIs). The peripheral device interface 175 enables connectivity with external hardware such as printers or external storage arrays.

The network 190 represents any communication infrastructure capable of facilitating data exchange between computing entities. In some embodiments, the network 190 corresponds to a local area network (LAN), a wide area network (WAN), or the global Internet. In high-security applications, the network 190 may implement firewalls or intrusion detection systems to protect transmitted data.

The computing system 100 is illustrated as being in communication with multiple external devices, including a user computing device 145, an administrator computing device 185, and a third-party computing device 195. The user computing device 145 may be a smartphone, tablet, or laptop configured to execute client-side applications or interact with system services. The administrator computing device 185 may be a workstation or remote management console configured to perform oversight functions such as monitoring, auditing, and updating. The third-party computing device 195 may represent a partner system, vendor service, or external application interface that exchanges data with the computing system 100 via secure APIs.

In some embodiments, the computing system 100 may be deployed in a client-server model, where the computing system 100 acts as a backend server managing requests from client devices. In other embodiments, the computing system 100 may function within a cloud-native environment.

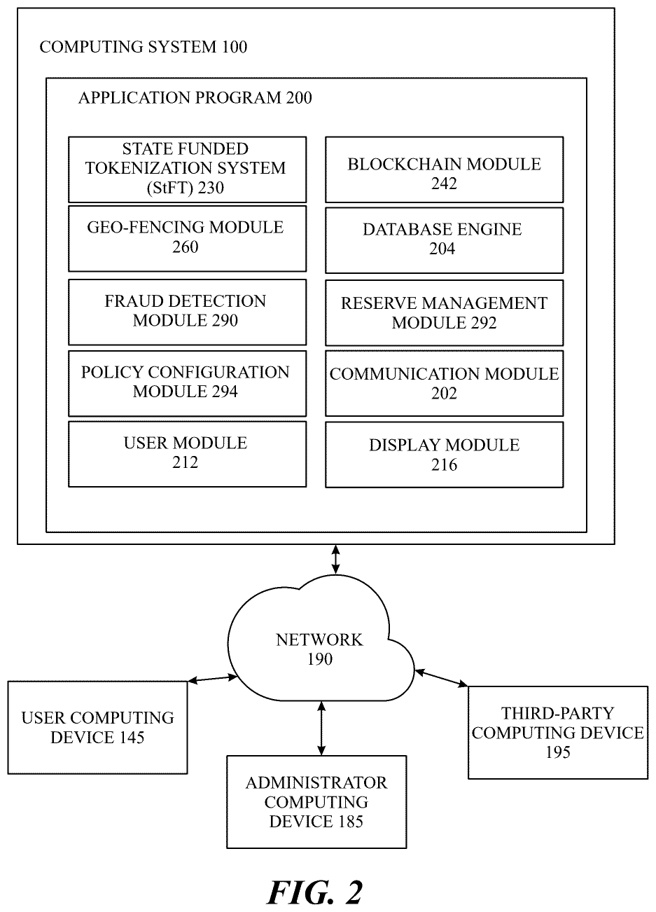

FIG. 2 illustrates an application program 200 and its constituent modules operating within the computing system 100. The computing system 100 executes the application program 200, which comprises the software modules and engines configured to perform the functionalities of the blockchain-based digital token system. The application program 200 includes a state funded tokenization system (StFT) 230, a blockchain module 242, a geo-fencing module 260, a fraud detection module 290, a reserve management module 292, a policy configuration module 294, a communication module 202, a database engine 204, a user module 212, and a display module 216. These modules and engines contain the necessary routines and data structures for performing specific tasks within the system and collectively manage the full lifecycle of state-backed digital tokens.

The state funded tokenization system (StFT) 230 is configured to issue, track, and manage the lifecycle of digital tokens representing state-backed financial incentives. The StFT 230 interfaces with a state treasury or administrative system to receive authorization for token issuance, generates digital tokens pegged at a one-to-one ratio to a fiat currency, assigns each token a unique identifier and metadata including a usage counter and redemption status, enforces multi-transaction requirements by initializing and incrementing the usage counter for each validated transaction, and triggers redemption and token burning operations upon completion of the configurable transaction cycle threshold. The blockchain module 242 is configured to record, validate, and enforce all token-related transactions and smart contract logic within a permissioned distributed ledger. The blockchain module 242 includes a node-based architecture operated by authorized entities, maintains synchronized copies of the ledger, participates in a consensus mechanism such as Proof-of-Authority or Proof-of-Stake, and deploys smart contracts that manage minting, transaction count updates, geographic constraint verification, redeemable status marking, and token burn initiation. The geo-fencing module 260 is configured to restrict the use of state-backed digital tokens to authorized geographic areas by validating the physical location of each transaction through a two-point authentication process that verifies both the registered identity of the merchant and the real-time, cryptographically signed location data of the transaction against the authorized geographic boundary.

The communication module 202 is configured for receiving, processing, and transmitting user commands and data streams between the user computing device 145, the administrator computing device 185, and the third-party computing device 195 via the network 190. The communication module 202 maintains communication sessions with the various devices and allows users and administrators to exchange information regarding token transactions, redemption requests, and system notifications. The database engine 204 is configured to facilitate the storage, management, and retrieval of data to and from one or more storage mediums maintained by the system, including token metadata, merchant registry records, user account information, transaction logs, geographic boundary definitions, and policy configuration parameters. The user module 212 stores user preferences, account information, historical usage data, and personal information, and facilitates the creation of user profiles for users, administrators, and other participants in the system. The display module 216 is configured to generate and display one or more graphic user interfaces, including the dual-compartment digital wallet interface that visually separates non-redeemable tokens from redeemable tokens and presents each token's usage counter, transaction history, and geo-verification outcomes. The display module 216 also displays information, notifications, and alerts to the user device. The computing system 100 running the application program 200 communicates via the network 190 with the user computing device 145, the administrator computing device 185, and the third-party computing device 195, as depicted in the lower portion of FIG. 2.

The application program 200 may further include a fraud detection module 290 configured to identify artificial manipulation of the multi-cycle circulation requirement. The fraud detection module 290 may employ machine learning algorithms to analyze transaction patterns, timing relationships, and entity relationship graphs recorded on the permissioned blockchain via the blockchain module 242. The fraud detection module 290 may monitor for velocity anomalies, ring-laundering patterns, and related-party transactions, and may automatically suspend transaction processing for affected tokens, generate alerts to authorized administrators through the administrative dashboard rendered by the display module 216, and record detected anomalies immutably on the permissioned blockchain.

The application program 200 may further include a reserve management module 292 configured to maintain alignment between the circulating digital token supply and the fiat currency held in the state-managed reserve account. The reserve management module 292 may interface with the state funded tokenization system 230 to verify that each minting operation is backed by a corresponding fiat deposit. The reserve management module 292 may perform automated or semi-automated auditing to periodically verify parity between the total fiat amount in the reserve and the total value of digital tokens in circulation on the permissioned blockchain, and may generate audit records accessible to state administrators through the administrative dashboard.

The application program 200 may further include a policy configuration module 294 configured to provide authorized state administrators with an interface for defining and updating operational parameters governing the digital token lifecycle. The policy configuration module 294 may allow administrators to set and modify the configurable transaction cycle threshold, define authorized geographic boundaries at varying granularity levels including state, county, municipal, and economic zone boundaries, configure redemption pathway thresholds, set token expiration policies, and define consensus mechanism parameters including selection of Proof of State as the active consensus mechanism. Parameters set through the policy configuration module 294 may be stored in the policy configuration store maintained by the database engine 204 and read by the parameterized smart contract templates deployed through the blockchain module 242.

FIG. 3 illustrates a block diagram indicative of the operational flow of the state funded tokenization system (StFT) 230, showing the components and decision points in the lifecycle of a state-backed digital token. The process begins with StFT token issuance 302, where a state-backed digital token is minted and pegged to a fiat currency at a one-to-one ratio. Each token is assigned a unique identifier and initialized with metadata, such as a transaction counter set to zero, a redemption status set to non-redeemable, and geographic restrictions defining the authorized geographic boundary. Once issued, the token is transferred to a wallet 304, where it resides in a non-redeemable state. The wallet 304 may be a mobile or web-based digital wallet application that enables users to view token balances and track transaction history through the dual-compartment interface.

When a user initiates a payment, the system processes the request through transaction 306, which triggers a series of verification steps. Merchant check 308 validates the identity of the receiving merchant by cross-referencing the merchant against a pre-approved merchant list stored in registry 310. The registry 310 maintains records of authorized merchants including their digital certificates and registered geographic coordinates. If the merchant is authorized, the process advances to location check 313, where real-time geographic data is retrieved from location data 312. The location data 312 comprises cryptographically signed geographic coordinates transmitted from the merchant's point-of-sale device at the time of transaction. The system then performs geo-fence validation 320 to determine if the transaction complies with the authorized geographic boundary. Geo-fence validation 320 represents the decision point where the system evaluates both the merchant identity verification from merchant check 308 and the location verification from location check 313 against the defined geographic constraints.

If the transaction is determined to be invalid at geo-fence validation 320 because the location falls outside the authorized geographic boundary or because the merchant is not present in the registry 310, the system routes control to reject 316, which prevents the unauthorized token use and may generate a notification to the user and the administrative system. If the transaction is determined to be valid at geo-fence validation 320, the process continues to smart contract engine 314, which executes the necessary token updates on the permissioned blockchain. The smart contract engine 314 increments the token's transaction counter, records the transaction event on the distributed ledger, and evaluates whether the usage counter meets or exceeds the configurable transaction cycle threshold. Following validation, update token status 322 reflects the outcome of the smart contract engine's evaluation. If the token has completed the required number of validated transactions, update token status 322 changes the token's redemption status from non-redeemable to redeemable and causes the wallet interface to move the token from the non-redeemable compartment to the redeemable compartment. Once eligible, the user may initiate a redemption request via the redemption interface 324, which processes the redemption through the appropriate pathway, directing larger redemptions through a state treasury exchange and smaller redemptions through retail partners or automated teller machines. After successful redemption, token burn 326 permanently removes the token from circulation by executing a smart contract burn operation that records the event on the blockchain ledger to maintain supply consistency and preserve compliance with the system's lifecycle management policies.

FIG. 4 illustrates a block diagram indicative of the operational flow of the state digital treasury mint 403 system within the StFT module, showing the functional components involved in the issuance, validation, and redemption of state-backed digital tokens. The process begins with an incentive system 402, where an approved economic incentive, such as a tax credit or rebate, triggers the creation of a digital token. The incentive system 402 represents the state-level authorization mechanism that approves the disbursement of fiscal instruments and communicates the approval to the tokenization system. The request is processed by state digital treasury mint 403, which mints the token, assigns metadata including a unique identifier, transaction limits, and geographic constraints, and sets the rules for circulation. State digital treasury mint 403 represents the token minting and configuration engine that initializes each token with a usage counter set to zero, a redemption status set to non-redeemable, and the authorized geographic boundary parameters.

Once issued, the token is stored in wallet 304, where it remains in a non-redeemable state until it completes the required number of validated transactions. When a user initiates a transaction, the request is processed by transaction 306, which logs the transaction attempt and forwards the request for verification. At this stage, merchant check 308 validates the identity of the merchant receiving the token by cross-referencing the merchant's information with registry 310, which stores a list of authorized businesses eligible to accept state-backed tokens. In parallel, location check 313 retrieves real-time geographic data from location data 312 to determine where the transaction is occurring. The transaction is then evaluated under geo-fencing rules 406, which define the specific geographic boundaries applicable to this token. The geo-fencing rules 406 represent the policy-configurable boundary definitions that may be set at the state, county, municipal, or economic zone level by a state administrator. This data is processed through geo-fence validation 320, which determines whether the transaction is valid by confirming both the merchant identity and the transaction location against the authorized geographic boundary defined by geo-fencing rules 406.

If the transaction is outside the approved area or does not meet compliance requirements as determined by geo-fence validation 320, it is rejected by reject 316 and is not recorded on the blockchain. If the transaction is valid, smart contract engine 314 executes the necessary token updates, increments the cycle count, and records the transaction on the blockchain ledger. When the token meets the predefined circulation threshold, update token status 322 marks the token as redeemable and updates the wallet interface accordingly, moving the token to the redeemable compartment. Once eligible, the user may initiate a redemption request via redemption interface 324, which processes the token through a state exchange or authorized retail outlet. Upon successful redemption, token burn 326 permanently removes the token from circulation, ensuring it cannot be reused, and records the burn event on the blockchain to maintain transparency and compliance with the system's lifecycle policies. The distinction between FIG. 3 and FIG. 4 is the inclusion of the incentive system 402, the state digital treasury mint 403 engine, and the explicit geo-fencing rules 406 as separate components feeding into the operational flow, illustrating how state-level authorization and configurable policy parameters initiate and govern the token lifecycle.

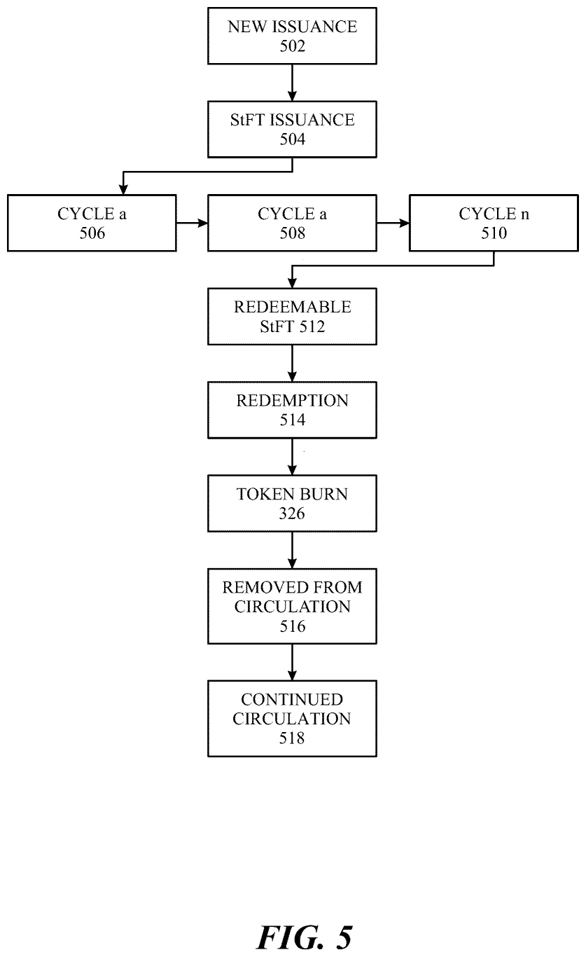

FIG. 5 illustrates a block diagram representing the lifecycle of a state-backed digital token from issuance through circulation and potential redemption. The process begins with new issuance 502, where a state-authorized incentive program initiates the creation of a digital token. In response, StFT issuance 504 mints the token and records it to the blockchain with an assigned identifier, metadata, and circulation rules including the configurable transaction cycle threshold and the authorized geographic boundary. The token is then placed into circulation for economic activity, proceeding through a series of validated transaction cycles. These cycles are represented as cycle a 506, cycle a 508, and cycle n 510, where each cycle denotes a transfer of the token within the authorized geographic zone in which the transaction is verified by the geo-fencing module and recorded by the smart contract engine. The system may be configured to require a predefined number of such cycles, denoted abstractly by “n,” before a token is eligible for redemption. The use of the variable “n” indicates that the threshold is configurable and may be adjusted by a state administrator based on policy objectives without requiring changes to the smart contract code.

Upon completion of the required number of validated transaction cycles, the token transitions to redeemable StFT 512, signifying that it has met the criteria for redemption and that the smart contract engine has updated its redemption status from non-redeemable to redeemable. At this stage, the token appears in the redeemable compartment of the user's dual-compartment digital wallet. A user may then initiate a redemption request, shown as redemption 514, to convert the digital token back into fiat currency or to claim a corresponding benefit via an approved state or retail redemption interface. Following redemption, token burn 326 is executed by the system to permanently remove the redeemed token from circulation. This process ensures that the token cannot be reused or transferred further. Once burned, the token is classified as removed from circulation 516, completing its lifecycle as a state-backed digital incentive and ensuring that the circulating token supply remains aligned with the underlying fiat reserve. Alternatively, if redemption is not immediately pursued, the token may continue to circulate within the ecosystem as shown in continued circulation 518, allowing further local economic activity until the user chooses to redeem. The continued circulation 518 path illustrates that meeting the transaction cycle threshold does not compel immediate redemption; rather, the token remains usable in the local economy and the user retains the option to redeem at a time of their choosing.

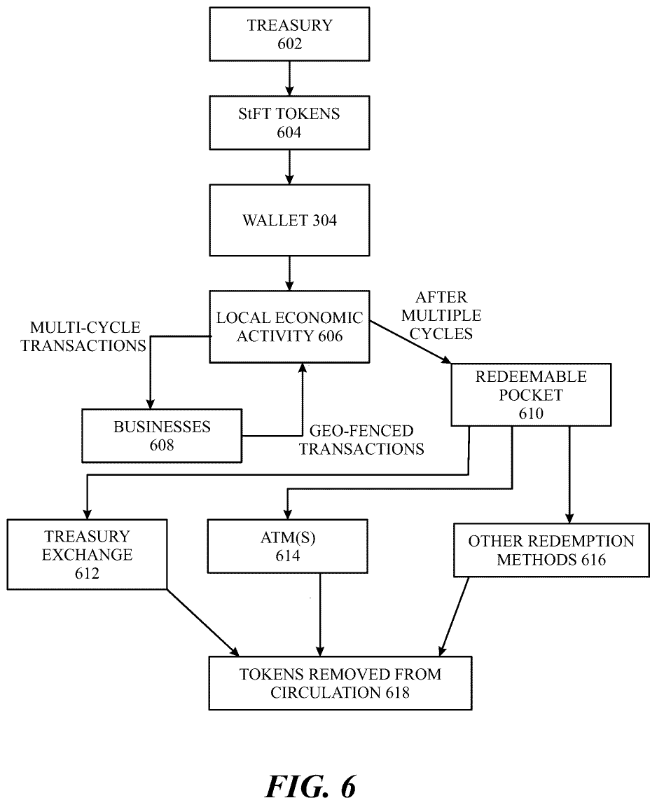

FIG. 6 illustrates a block diagram indicative of the economic and transactional flow of state-backed digital tokens from issuance to final removal from circulation, highlighting how tokens are used in local economies and ultimately redeemed. The process begins with treasury 602, which represents a state-managed financial authority responsible for issuing tokenized economic incentives. From the treasury 602, StFT tokens 604 are minted and distributed to eligible recipients through wallet 304, which stores and manages the tokens during their lifecycle. The wallet 304 is the dual-compartment digital wallet interface through which users view their non-redeemable and redeemable token balances, initiate transactions, and submit redemption requests.

Once received in the wallet 304, tokens are used to engage in local economic activity 606, which may include purchases, exchanges, or transfers within a designated jurisdiction. This activity involves multi-cycle transactions with businesses 608, meaning the token must circulate through a specified number of valid, geo-fenced transactions before it becomes eligible for redemption. The multi-cycle transactions label on the left side of the diagram indicates the repeated circulation requirement enforced by the smart contract engine, and the geo-fenced transactions label connecting businesses 608 to the broader flow indicates that each transaction is validated by the geo-fencing module to confirm it occurs within the authorized geographic boundary. As tokens continue to participate in local transactions and accumulate valid uses, they eventually meet the system-defined threshold and are moved into the redeemable pocket 610 of the digital wallet. The redeemable pocket 610 corresponds to the second compartment of the dual-compartment wallet interface, where tokens that have met or exceeded the configurable transaction cycle threshold are displayed as eligible for conversion to fiat currency. The transition from active circulation to redeemability occurs after multiple cycles, as indicated by the label “after multiple cycles” on the diagram, and is enforced by the underlying smart contract logic and location-based transaction verification mechanisms.

Once redeemable, users may choose from multiple redemption pathways. Treasury exchange 612 represents the first redemption pathway, where tokens may be directly exchanged for fiat or credited via a state-backed interface connected to the state-managed reserve account. This pathway may be used for redemption amounts exceeding a predetermined monetary threshold. ATM(s) 614 represents automated teller machines integrated with the system, allowing for automated or cash-based redemption at physical locations for redemption amounts at or below the predetermined monetary threshold. Other redemption methods 616 represent additional channels that may include retail-based exchanges, partner banks, digital banking platforms, or mobile banking services. After successful redemption through any of these channels, tokens are routed to tokens removed from circulation 618, where they are permanently deactivated through the token burning operation executed by the smart contract engine. The burn event is recorded on the permissioned blockchain to provide a permanent audit record. This final step ensures the token supply remains aligned with the treasury reserve and maintains the integrity of the system's issuance and redemption policies, preventing redeemed tokens from re-entering circulation and preserving the one-to-one peg between circulating tokens and the fiat reserve.

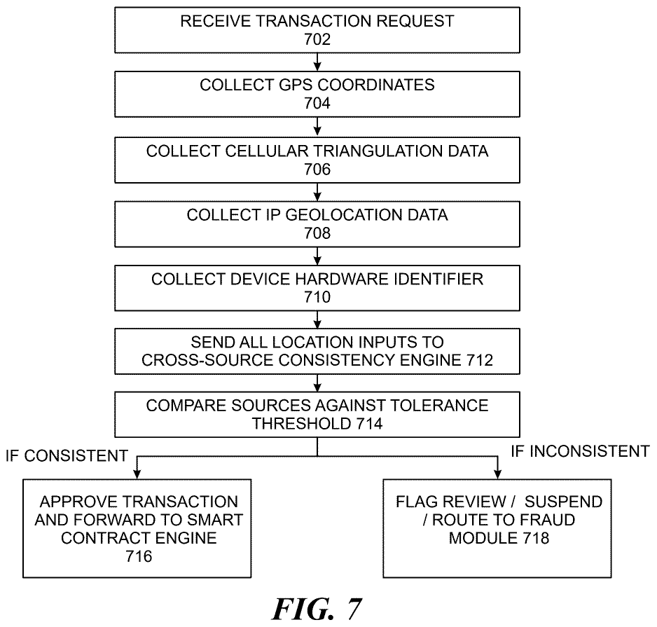

FIG. 7 illustrates a block diagram indicative of a multi-source geo-verification flow within the geo-fencing module 260. The flow begins at step 702, where the system receives a transaction request initiated by a user or merchant within the tokenization framework. Upon receipt of the transaction request, the system proceeds to step 704, where it collects GPS coordinates from the merchant's point-of-sale device or the transacting user's device to establish a primary geographic reference point for the transaction. The flow then advances to step 706, where the system collects cellular triangulation data derived from nearby cell tower signals to provide a second, independent estimate of the transaction's physical location. At step 708, the system collects IP geolocation data determined from the network address associated with the transaction request, providing a third independent location signal. The flow continues to step 710, where the system collects a device hardware identifier from the transacting device, which may be cross-referenced against known device registrations to verify device authenticity and location history. After collecting all four independent location inputs, the flow proceeds to step 712, where the system sends all location inputs to a cross-source consistency engine. The cross-source consistency engine aggregates the GPS coordinates, the cellular triangulation data, the IP geolocation data, and the device hardware identifier into a unified verification context. At step 714, the cross-source consistency engine compares the location signals from each source against a configurable tolerance threshold to determine whether the reported locations are mutually consistent. The tolerance threshold defines the maximum permissible geographic deviation between any two independent sources before a discrepancy is flagged. If the cross-source consistency engine determines that all location signals are consistent within the configurable tolerance threshold, the flow proceeds to step 716, where the transaction is approved and forwarded to the smart contract engine for execution, including incrementing the token's usage counter and recording the validated transaction on the permissioned blockchain. If the cross-source consistency engine determines that discrepancies between one or more sources exceed the configurable tolerance threshold, the flow proceeds to step 718, where the transaction is flagged for review, suspended from further processing, and routed to the fraud detection module 290 for additional analysis or to authorized administrators through the administrative dashboard for manual review.

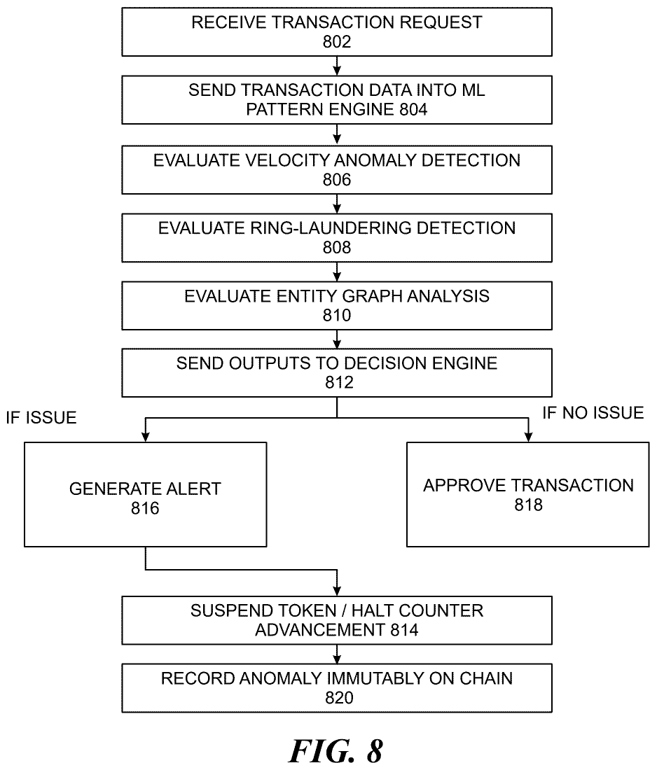

FIG. 8 illustrates a block diagram indicative of a fraud detection flow within the fraud detection module 290. The flow begins at step 802, where the system receives a transaction request involving a state-backed digital token. Upon receipt of the transaction request, the flow proceeds to step 804, where the system sends the transaction data into a machine learning (ML) pattern engine. The ML pattern engine is configured to analyze the transaction data against trained models to identify patterns indicative of artificial manipulation of the multi-cycle circulation requirement. The ML pattern engine sequentially evaluates the transaction data through three analysis stages. At step 806, the ML pattern engine evaluates velocity anomaly detection, which examines whether the token has completed an unusually high number of transaction cycles within a compressed time period relative to historical norms established from prior transaction data recorded on the permissioned blockchain. At step 808, the ML pattern engine evaluates ring-laundering detection, which identifies patterns in which a token circulates between a closed set of entities without genuine economic activity, as determined by analyzing the sequence and repetition of counterparties involved in the token's transaction history. At step 810, the ML pattern engine evaluates entity graph analysis, which examines Employer Identification Number registrations, ownership records, and corporate relationship structures to detect related-party transactions in which the sender and receiver share common ownership or control. After completing the three analysis stages, the flow proceeds to step 812, where the ML pattern engine sends its outputs to a decision engine. The decision engine aggregates the classification results from velocity anomaly detection 806, ring-laundering detection 808, and entity graph analysis 810 and renders a determination as to whether the transaction exhibits any flagged patterns. If the decision engine determines that no issues are present, the flow proceeds to step 818, where the transaction is approved and forwarded for continued processing by the smart contract engine. If the decision engine determines that one or more issues are detected, the flow branches to step 816, where the system generates an alert and sends a notification to authorized administrators through the administrative dashboard. From the alert generation at step 816, the flow continues to step 814, where the system suspends the affected token and halts further counter advancement, preventing the token from accumulating additional validated transaction cycles while the flagged activity is under review. The flow then proceeds to step 820, where the system records the detected anomaly immutably on the permissioned blockchain, creating a permanent audit record of the flagged pattern, the associated token identifier, and the timestamp of the detection event for compliance and regulatory purposes.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A system for enforcing geographically restricted multi-cycle circulation of government-backed digital incentive instruments, comprising:
a token issuance engine configured to generate jurisdiction-restricted digital tokens each backed by a state-managed fiat reserve and initialized in a non-redeemable state;
a circulation enforcement module configured to gate each token's transition to a redeemable state on completion of a configurable minimum number of cryptographically verified transfer events each occurring within an authorized geographic boundary defined by the issuing jurisdiction; and
a token lifecycle manager configured to execute an irreversible deactivation operation upon redemption and record the event on a distributed ledger.

2. The system of claim 1, further comprising:
a permissioned blockchain network comprising a plurality of nodes operated by authorized entities, the permissioned blockchain network configured to record token transactions on a distributed ledger;
a state funded tokenization system configured to mint digital tokens, each digital token pegged at a one-to-one ratio to a fiat currency and backed by a corresponding amount held in a state-managed reserve account, wherein each digital token is assigned a unique identifier and initialized with metadata comprising an issuance timestamp, a usage counter set to zero, a redemption status set to non-redeemable, and one or more location-related attributes defining an authorized geographic boundary;
a geo-fencing module configured to validate, for each token transaction, that the transaction occurs within the authorized geographic boundary by performing a two-point authentication process comprising: verifying a registered digital certificate of a merchant associated with the transaction against a merchant registry, and comparing real-time, cryptographically signed location data transmitted during the transaction against a whitelist of permissible geographic regions, wherein the geo-fencing module is configured to reject the transaction upon a determination that either the merchant is not in the merchant registry or the real-time location data falls outside the authorized geographic boundary;
a smart contract engine deployed on the permissioned blockchain network and configured to, for each validated token transaction: increment the usage counter of the digital token, evaluate whether the usage counter meets or exceeds a configurable transaction cycle threshold, and upon a determination that the usage counter meets or exceeds the configurable transaction cycle threshold, update the redemption status of the digital token from non-redeemable to redeemable; and
a digital wallet interface configured to display, for a user, a dual-compartment view comprising a first compartment for non-redeemable tokens having a usage counter below the configurable transaction cycle threshold and a second compartment for redeemable tokens having a usage counter that meets or exceeds the configurable transaction cycle threshold.

3. The system of claim 2, wherein the smart contract engine is further configured to, upon redemption of a redeemable digital token, execute a token burning operation that permanently removes the redeemed digital token from circulation on the permissioned blockchain network and records the burn event on the distributed ledger.

4. The system of claim 1, wherein the geo-fencing module is configured to determine geographic compliance of a proposed token transfer using a plurality of location-related inputs comprising at least two of: global positioning system (GPS) data, cellular triangulation data, internet protocol (IP) geolocation data, and device hardware identifier data associated with a merchant point-of-sale device.

5. The system of claim 4, wherein the geo-fencing module further comprises a cross-source consistency engine configured to compare the plurality of location-related inputs against one another and to reject, suspend, delay, or flag the proposed token transfer for review when the plurality of location-related inputs are inconsistent beyond a predefined threshold, thereby detecting geographic spoofing, proxy use, synthetic location data, or device-location mismatch prior to smart contract execution.

6. The system of claim 1, further comprising a fraud detection module comprising a machine-learning pattern engine configured to analyze token transfer data to detect one or more of: velocity anomalies inconsistent with expected local economic activity, ring-laundering patterns comprising repeated circular transfer sequences among a defined set of participants, and affiliated-entity looping identified through entity graph analysis of transfer relationships, wherein upon detection the fraud detection module is configured to suspend advancement of a usage counter associated with a corresponding token and record an anomaly event as an immutable ledger entry.

7. The system of claim 2, wherein the authorized geographic boundary is defined at a granularity selected from the group consisting of a state boundary, a county boundary, a municipal boundary, and an economic zone, and wherein the authorized geographic boundary is reconfigurable by a state administrator.

8. A computer-implemented method for enforcing geographically restricted multi-cycle circulation of government-backed digital incentive instruments, the method comprising:
generating, by a token issuance engine executing on one or more processors, jurisdiction-restricted digital tokens each backed by a state-managed fiat reserve and initialized in a non-redeemable state;
gating, by a circulation enforcement module, each token's transition to a redeemable state on completion of a configurable minimum number of cryptographically verified transfer events each occurring within an authorized geographic boundary defined by the issuing jurisdiction; and
executing, by a token lifecycle manager, an irreversible deactivation operation upon redemption and recording the event on a distributed ledger.

9. The method of claim 8, further comprising:
minting, by a state funded tokenization system executing on one or more processors, a plurality of digital tokens on a permissioned blockchain, each digital token pegged at a one-to-one ratio to a fiat currency, backed by a state-managed reserve, and initialized in a non-redeemable state with a usage counter set to zero;
delivering the plurality of digital tokens to respective digital wallets of recipient users, each digital wallet comprising a dual-compartment interface with a non-redeemable compartment and a redeemable compartment, wherein each minted digital token is initially placed in the non-redeemable compartment;
receiving, at a smart contract engine on the permissioned blockchain, a transaction request to transfer a digital token from a first user to a merchant;
performing, by a geo-fencing module, a two-point authentication for the transaction request, the two-point authentication comprising: validating an identity of the merchant by cross-referencing a digital certificate of the merchant against a merchant registry, and verifying that a real-time, cryptographically signed geographic location of the transaction falls within an authorized geographic boundary;
upon successful two-point authentication, executing, by the smart contract engine, the transaction request by transferring the digital token, incrementing the usage counter of the digital token, and recording the transaction on the permissioned blockchain;
upon a determination that the usage counter of the digital token meets or exceeds a predefined transaction cycle threshold, updating, by the smart contract engine, the digital token from the non-redeemable state to a redeemable state and causing the digital wallet to move the digital token from the non-redeemable compartment to the redeemable compartment; and
rejecting, by the geo-fencing module, the transaction request upon a determination that the real-time geographic location falls outside the authorized geographic boundary or that the merchant is not present in the merchant registry.

10. The method of claim 9, further comprising:
receiving a redemption request for a digital token in the redeemable state;
processing the redemption request through a redemption pathway to convert the digital token to fiat currency from the state-managed reserve; and
executing a token burning operation via the smart contract engine to permanently remove the digital token from circulation on the permissioned blockchain and recording the burn event on a distributed ledger.

11. The method of claim 10, wherein processing the redemption request comprises selecting the redemption pathway based on a monetary amount of the redemption request, wherein a redemption request exceeding a predetermined monetary threshold is directed to a state treasury exchange interface and a redemption request at or below the predetermined monetary threshold is directed to at least one of a retail automated teller machine, a partner bank, and a digital banking platform.

12. The method of claim 10, wherein performing the two-point authentication further comprises receiving the real-time geographic location from a point-of-sale device of the merchant, the real-time geographic location being cryptographically signed to prevent spoofing, and comparing the real-time geographic location against registered geographic coordinates stored in the merchant registry.

13. The method of claim 10, further comprising generating, by the permissioned blockchain, an immutable audit record for each of: a token issuance event, the transaction request, a redemption event, and a token burn event, the immutable audit record being accessible through an administrative dashboard by authorized state personnel for compliance monitoring.

14. The method of claim 10, wherein the predefined transaction cycle threshold is configurable on a per-program basis by a state administrator, and wherein the authorized geographic boundary is adjustable without requiring modification to smart contract code deployed on the permissioned blockchain.

15. The method of claim 10, wherein each digital token is further associated with metadata linking the digital token to a specific fiscal instrument selected from the group consisting of a tax credit, a rebate, a subsidy, an emergency relief disbursement, a natural disaster recovery fund, an infrastructure project credit, and a public health funding allocation.

16. A non-transitory computer-readable medium storing instructions that, when executed by one or more processors, cause the one or more processors to:
generate jurisdiction-restricted digital tokens each backed by a state-managed fiat reserve and initialized in a non-redeemable state;
gate each token's transition to a redeemable state on completion of a configurable minimum number of cryptographically verified transfer events each occurring within an authorized geographic boundary defined by the issuing jurisdiction; and
execute an irreversible deactivation operation upon redemption and record the event on a distributed ledger.

17. The non-transitory computer-readable medium of claim 16, wherein the instructions further cause the one or more processors to:
mint a digital token on a permissioned blockchain, the digital token pegged at a one-to-one ratio to a fiat currency and backed by a state-managed reserve account, the digital token having a unique identifier, a usage counter initialized to zero, and a redemption status set to non-redeemable;
store the digital token in a non-redeemable compartment of a dual-compartment digital wallet interface associated with a recipient user;
upon receiving a transaction request involving the digital token, perform a geo-fencing validation comprising verifying a registered identity of a merchant party to the transaction against a merchant registry and comparing a real-time, cryptographically signed location of the transaction against an authorized geographic boundary;
reject the transaction request upon a determination that the real-time location falls outside the authorized geographic boundary or that the merchant is not verified against the merchant registry;
upon successful geo-fencing validation, execute the transaction request by transferring the digital token, incrementing the usage counter, and recording the transaction on the permissioned blockchain;
upon a determination that the usage counter meets or exceeds a configurable transaction cycle threshold, update the redemption status from non-redeemable to redeemable and cause the digital wallet interface to display the digital token in a redeemable compartment of the dual-compartment digital wallet interface; and
upon receiving a redemption request for the digital token having the redeemable redemption status, process the redemption request and execute a token burning operation to permanently remove the digital token from circulation on the permissioned blockchain.

18. The non-transitory computer-readable medium of claim 17, wherein the instructions further cause the one or more processors to maintain the state-managed reserve account such that a total fiat amount in the state-managed reserve account corresponds to a total value of digital tokens in circulation on the permissioned blockchain, and to periodically audit parity between the total fiat amount and the total value of digital tokens in circulation.

19. The non-transitory computer-readable medium of claim 17, wherein performing the geo-fencing validation further comprises a two-point authentication process in which a first authentication step validates a digital certificate of the merchant containing a geospatial identifier, and a second authentication step verifies the real-time, cryptographically signed location data received from a point-of-sale system of the merchant against the authorized geographic boundary.

20. The non-transitory computer-readable medium of claim 17, wherein the instructions further cause the one or more processors to process the redemption request through a first redemption pathway via a state treasury exchange interface for redemption amounts exceeding a predetermined monetary threshold, and through a second redemption pathway via at least one of a retail automated teller machine and a digital banking platform for redemption amounts at or below the predetermined monetary threshold, and wherein executing the token burning operation comprises recording a burn event on the permissioned blockchain to provide a permanent audit record and to maintain alignment between a circulating token supply and the state-managed reserve account.
